(19) United States
(12) Patent Application Publication
(10) Pub. No.: US 2002/0152255 A1
(43) Pub. Date: Oct. 17, 2002

(54) Accessibility on demand

(75) Inventors: Newton James Smith JR., Austin, TX (US); Herman Rodriguez, Austin, TX (US); Clifford Jay Spinac, Austin, TX (US)

Correspondence Address: Robert H. Frantz, P.O. Box 23324, Oklahoma City, OK, 73123-2334, US

(73) Assignee: International Business Machines Corporation, Armonk, NY (US)

(21) Appl. No.: 09/779,372

(22) Filed: Feb. 8, 2001

(51) Int. Cl. G06F 9/00

(52) U.S. Cl. 709/102

(57) ABSTRACT

Accessibility profiles are created for different environments, application programs, and system functions. Environmental conditions may include time of day, telephone numbers dialed, caller ID, level of background noise, etc. Users can define accessibility profiles for each program they use, which determine preferred speaker volume settings, display settings, keyboard and keypad characteristics, and may automatically invoke companion programs such as voice recognizors, text-to-speech converters, and gesture recognizors. Accessibility profiles are organized and stored in a processor-readable repository, and are retrieved upon user activation of an application program or system function such as a word processor, auto-dialer, e-mail reader, etc. The system parses the appropriate accessibility profile, adjusts the available system accessibility settings, and launches any associated companion programs. The user can also select and enable a certain accessibility profile by selecting a menu option or GUI icon, or by operating a system button such as a toggle switch.

### BACKGROUND OF THE INVENTION

1. Field of the Invention

The present invention relates generally to processor and computer-based devices which allow a user to select special needs accessibility features, such as display, audio, keyboard and pointing device settings and preferences on computers, personal digital assistants, telephones, Internet appliances, and the like.

2. Description of the Related Art

Many modem devices used in daily life are processor-based. Some devices, such as personal computers (“PC”) and personal digital assistants (“PDA”) are equipped with processors capable of executing sophisticated programs such as word processors, web browsers, voice recognizors, text-to-speech converters, and handwriting recognizors, and are provided with full or partial keyboards, touch-sensitive pointing devices and screens, color graphic displays, speakers, microphones and cameras. Many other devices are provided with low-cost, highly specialized processors, such as those found in microwave ovens, cable converter boxes, televisions and audio entertainment systems, digital answering machines, and wireless telephones. In the latter case, the displays, keyboards, pointing devices, and audio peripherals may be cost-reduced devices such as LED or LCD displays, multifunction keypads, and up/down/left/right keys. Most electronic devices in widespread use today can be viewed in one of these two categories, to a greater or lesser degree.

Turning to FIG. 1, a generalized view of a microprocessor-based device (10) is shown. The heart of the device is a processor (11) which executes one or more software or firmware programs, and which typically has some form of persistent memory (15) such as FlashROM or hard disks. Many devices (10) are equipped with a display driver (12) for driving a display (104), such as a PC VGA card for a computer monitor or an LCD driver integrated circuit for an LCD display. In some systems, audio output may be a function, and the device may be provided with an audio driver (13) and one or more speakers (102, 103), such as a PC sound card and speakers or a headset driver amplifier and headset. A microphone (16) and camera (17) may be supplied in some configurations. More sophisticated or advanced devices, such as personal computers, are typically provided with a full keyboard and pointing device, while others may be provided with a specialized or custom keypad (14).

Many microprocessor-based devices (10) are also provided with communications capability, such as a wireless transceiver (105), network interface to a computer network (19), or modem or telephony interface to a telephone network (100).

The fundamental components in this arrangement describe in general the architecture of devices ranging from cell phones, to appliances, to personal computers. In each individual case, the type of processor employed and peripherals provided are varied to create a different device with greater or lesser sophistication, cost and capability.

Many microprocessor-based systems have adjustments which may be individually controlled and set by a user, depending on environmental conditions and the user's ability to interact with the device. For example, a cellular phone typically has adjustments for speaker volume, ring type and volume, and LCD display contrast and brightness. It may also have a setting to enable and disable beep tones when to provide audible feedback when a key is successfully pressed. Personal computers are equipped with user preferences including display brightness and contrast, font and icon size, keyboard speed, pointing device speed and sensitivity, pointer tail length, and speaker volume.

For users who have physical impairments which prevent normal interaction with the device, such as sight or hearing loss, reduced tactile sensitivity, or lack of fine motor skills, these individual settings may be very useful for adapting the device to their personal use.

However, typically, these settings are global in nature, and they remain set until the system is reconfigured otherwise. For example, a cell phone may provide a speaker volume setting which is effective for all calls made or received on the telephone. As such, the user may be required to adjust the volume when the environment changes, such as turning up the volume in the presence of background noise, and turning down the volume when in quieter environments, in order to enable the telephone to work properly with the user's hearing aid. In another example situation, a partially sight-impaired user of a personal computer may have to adjust the display contrast one way for use of a word processor program, and another way for use of a graphics-oriented program such as a photograph editor.

This global nature of these accessibility settings further presents a problem for individuals whose impairment is not constant all the time, and who interact with several programs or applications for which enhanced or modified accessibility is not always needed. This forces the user to constantly reconfigure the system for different accessibility settings as various programs are used.

One of the more advanced examples of a microprocessor-based device is a personal computer, such as an IBM-compatible PC equipped with LINUX or Microsoft's Windows [TM] operating system. These operating systems provide settings for special needs accessibility such as display font and icon size, mouse responsiveness and speed, keyboard “sticky keys” which allow normally simultaneous key combinations to be entered in sequence, etc. However, even these sophisticated systems do not provide different settings for different programs or environmental conditions, but only provide a global set of preferences for an individual user which are applied to all application programs run by that user.

Further, there are many programs which the physically challenged may run in conjunction with each other, such as a voice recognizor program with a word processor program for a user with severe arthritis, or a text-to-speech converter program with an e-mail reader for the visually impaired. However, in most systems, the user must “launch” these programs individually which may pose additional problems and inconveniences for a user with special needs.

Therefore, there is a need in the art for a system and method which provides “accessibility on demand” which assigns different accessibility settings and preferences with different programs, environmental conditions, and users. There is a need in the art for a system and method which allows a user to specify groups of accessibility profiles for each program the user may run, to define companion programs to be automatically launched with accessibility profiles for the companion programs, and to set environmental conditions which enable or select these groups of settings.

### BRIEF DESCRIPTION OF THE DRAWINGS

The following detailed description when taken in conjunction with the figures presented herein provide a complete disclosure of the invention.

FIG. 1 shows the generalized architecture of a processor-based device.

FIG. 2 illustrates the high-level method used to create and edit accessibility profiles.

FIG. 3 sets forth the high-level method used to enable different accessibility settings for different programs and to launch companion programs.

FIG. 4 depicts the functional organization of the preferred embodiment of the invention.

FIG. 5 shows an example graphical user interface dialog for creating and editing accessibility profiles.

### SUMMARY OF THE INVENTION

User-defined accessibility profiles are created for different environments, such as time of day or application environment (e.g., word processing applications, but not web browsing), or such as raising the volume level on a phone conversation (through a computer), but not while listening to a music CD. The profiles are organized and stored in processor-readable memory, and are retrieved upon activation of a program, operation of a system function, or automatic execution of a program. The processor parses the appropriate accessibility profile(s), adjusts the available system accessibility settings, and launches any associated companion program(s), which may themselves have accessibility profiles. The user can also select and enable a certain accessibility profile as needed by simply selecting a menu option or a toggle switch. As such, each user can define accessibility profiles for each program which determine preferred speaker volume settings, display settings, keyboard and keypad characteristics, and automatically invoked companion programs such as voice recognizors, text-to-speech converters, and gesture recognizors.

### DETAILED DESCRIPTION OF THE INVENTION

The invention is preferably realized as an application program in a personal computer, such as Linux or a Microsoft Windows compatible program, on a system which provides an application programming interface (“API”) group of functions for control of accessibility settings such as speaker volume, display characteristics (font, resolution, contrast, colors, etc.), keyboard characteristics (repeat speed, sticky keys, key maps, etc.), and pointing device characteristics (sensitivity, speed, pointer tail, etc.).

Further, the invention is preferably realized on a microprocessor-based system which provides some amount of persistent memory, such as a hard drive in a personal computer or battery-backed RAM in a handheld telephone.

It will be recognized by those skilled in the art that the invention as described herein may alternatively be implemented as fully custom firmware or software in processor-based systems which are not equipped with full operating systems, as well as software in less sophisticated devices, such as appliances and handheld or portable electronics. For example, it may be used to set system display, keyboard, and audio characteristics in a wireless telephone, or personal digital assistant.

Throughout this document, several terminology conventions are used in order to enable the disclosure to be viewed relative to more sophisticated microprocessor-based systems, such as personal computers, as well as to more function-specific microprocessor-based devices, such as wireless telephones, personal digital assistants (“PDA”) and Internet appliances. The term “application program” generally refers to a program that is added to a device or system, such as a word processor on a personal computer or a downloadable plug-in for a web-enabled wireless telephone. The term “system function” generally refers to a function inherent to the system, such as a programmable function key (“F-key”) on a personal computer or an autodial button on a wireless telephone. An accessibility profile can be “assigned” to a system function or to an application program, such that user selection or operation of that system function or application program causes the profile to be enabled. Further, additional “companion” system functions and/or application programs may be “associated” with a particular profile, such that when the system function or application program to which the particular profile is assigned is executed, the “associated” system functions and application programs are automatically operated. This may be useful to, for example, launch a voice recognition companion application program each time a word processor application program is operated.

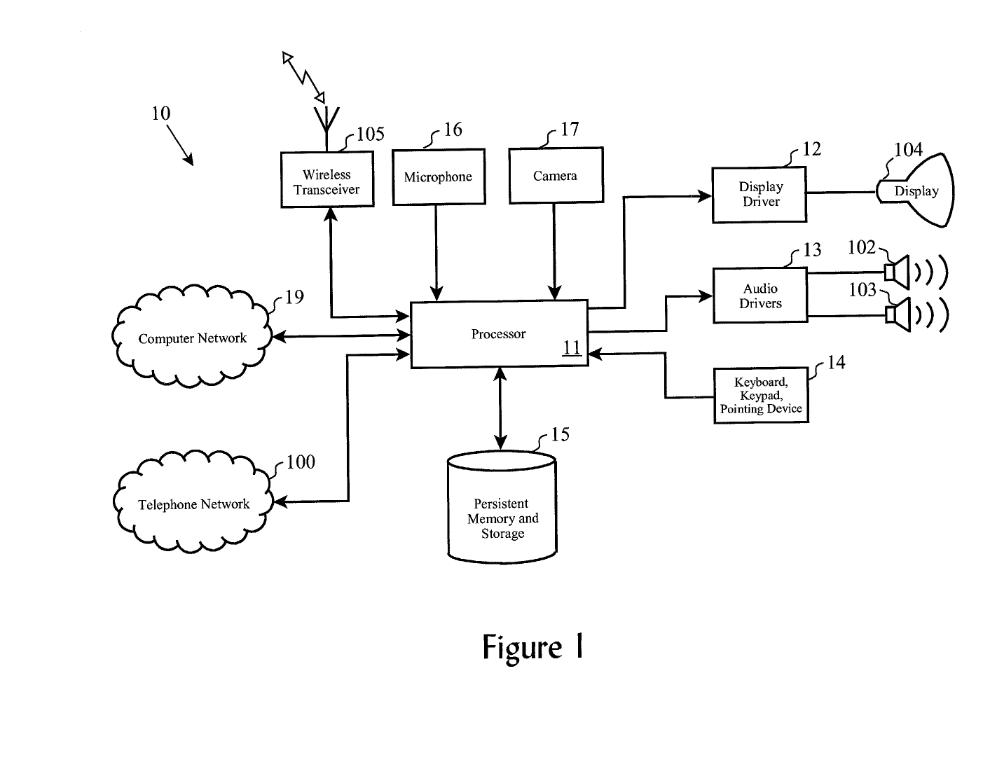

In the preferred embodiment, the general hardware architecture of FIG. 1 is adapted with the addition of an accessibility profile repository in persistent memory (15), such as on a PC hard drive in a file or database. The accessibility profile repository contains one or more accessibility profiles, each of which defines system accessibility settings assigned to specific application programs, system functions, and/or user ID's. These may be as simple as line entries in flat text files, may be records in a database, or entries in a system repository, which associate program attributes to accessibility profiles. TABLE 1 shows an example set of accessibility profiles for two hypothetical users, embodied in a text file in comma-separated variable (“CSV”) format.

TABLE 1
Example Accessibility Profiles

```
user=“bob”, appl=MSWord, font=18pts, contrast=high,
  companion1=“IBMViaVoice”, profile_name=“Bob's Word” <CR>
user=“bob”, appl=AutoDialer, called_number=“555-1212”,
  vol=max <CR>
user=“jill”, appl=LotusMail, vol=max,
  companion1=“CentigramTTS” <CR>
user=“jill”, appl=CDPlayer, vol=medium <CR>
user=*, font=medium, vol=medium, profile_name=“All Standard”,
  tone=medium, contrast=medium <CR>
<EOF>
```

In this example, a user “bob” has two accessibility profiles defined for two application programs, Microsoft Word and an AutoDialer program. For Microsoft Word, Bob has set the font to an easy to read large setting of 18 points, the display contrast to high, and enabled the automatic launching of the IBM ViaVoice voice recognition program to allow him to edit documents by voice. And, he has named this profile “Bob's Word”. For his AutoDialer program, he has set the speaker volume to maximum only when the dialed number is 555-1212, but not otherwise.

The second user, “jill”, also has two defined profiles, the first of which is for an e-mail program LotusMail. When she invokes LotusMail, the system speaker volume is set to maximum, and a companion text-to-speech conversion program is launched to enable her computer to audibly “read” her e-mail to her. Her second profile sets the system speaker volume to a medium level when running a CD player program.

Another profile, not associated with a specific user or application program, and which sets speaker volume to a medium level, fonts to a medium size, contrast to a medium setting, and tone to a medium level. This profile has been named “All Standard”.

These profiles alternatively can be stored in a binary format for embedded processing applications, as will be recognized by those skilled in the art. And, they can contain considerably more parameters than given in the example, to select specific fonts, colors, volume settings, etc. In another example shown in TABLE 2, a cellular telephone could set the microphone amplification based upon a number dialed, or the speaker volume based upon a caller ID value on a received call. This allows the user to create a customized list which automatically adjusts the system performance when the user calls a hearing impaired friend, or when the user receives a call from a friend who has respiratory difficulties and cannot speak loudly.

TABLE 2
Example Telephone Accessibility Profiles

CalledNumber=“976-1234”, mic_amp=max <EOR>
CallerID=“albert”, spkr_vol=max <EOR>

The general method for establishing and managing accessibility profiles is as follows:

1. Certain accessibility features of the system can be grouped into a single setting, called an accessibility profile. The accessibility profiles can preferably be named.

2. As part of the accessibility profile, the user can select one or more applications so that the accessibility features are automatically enabled whenever these applications are loaded.

3. When the application is loaded or executed, the accessibility profile becomes active, and when the application ends the accessibility profile is disabled.

4. The user also has the option of selecting and enabling an accessibility profile using a simple menu option, a hot-key, a toggle switch, or other user control.

5. When multiple accessibility profiles are enabled, the current application determines the current accessibility profile. For example, if loading the web browser enables special mouse operations, loading a game may load a different accessibility profile.

6. Accessibility profiles can be grouped into other profiles. For example, several font and backlight profiles can be created, and one of these can be enabled for mobile operation in low light, and other for desktop operation with office lighting.

7. Accessibility profiles can be transferred to another machine as a set, such that a guest user can enable the guest's customized accessibility features without having to reconfigure the foreign machine.

8. The accessibility profile also contains user-specific information, such as the user's name or ID, so that when the user logs onto a system such as Windows 2000, the accessibility profile(s) are available, and can be automatically enabled.

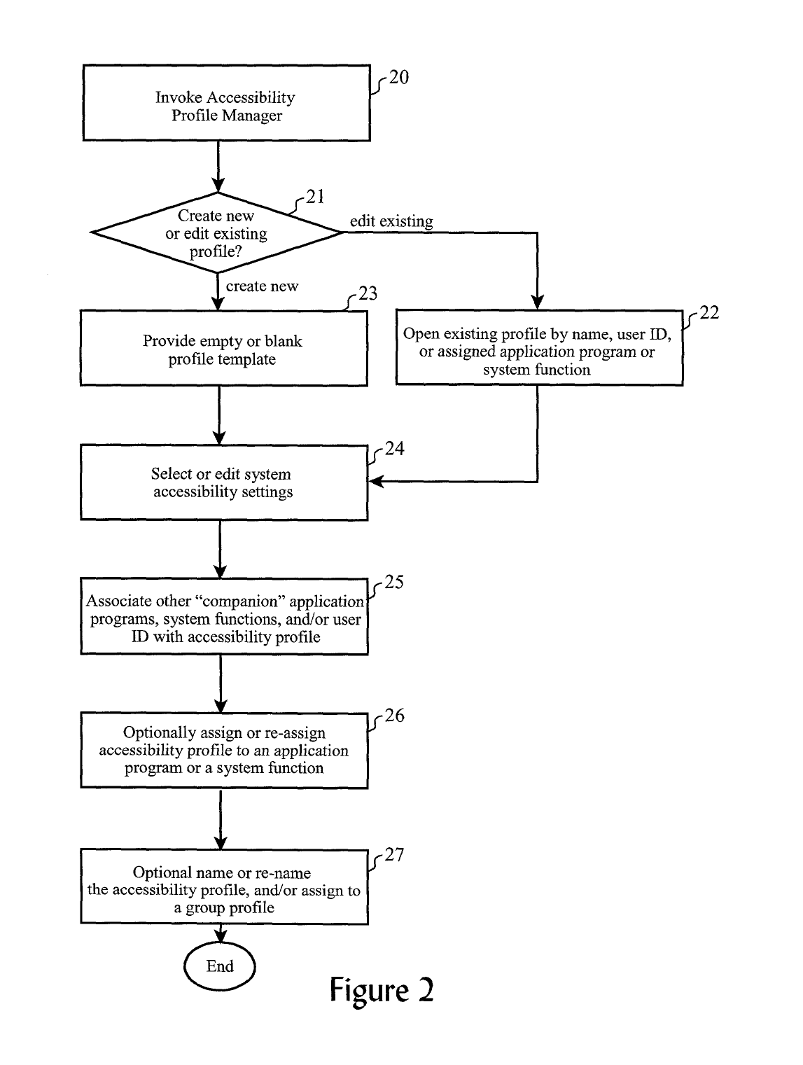

Turning to FIG. 2, the fundamental logical process of establishing new and editing existing accessibility profiles is given. First, the user invokes (20) a system function or program called the “Accessibility Profile Manager” to create or update accessibility profiles. In the preferred embodiment in a personal computer, this invocation may be made by selecting a tab or icon within the system configuration folder, such as the Accessibility Options icon in the Microsoft Windows[TM] Control Panel, or by selecting a desktop icon. Or, the Accessibility Profile Manager may be invoked by editing the “properties” of a program on a personal computer, such as “right clicking” on a desktop icon for a particular program and selecting the “properties” option in a Windows[TM]-based computer.

On other microprocessor-based systems such as a PDA or wireless telephone, the Accessibility Profile Manager may be accessed through a specific key or menu option.

The system then preferably provides a Graphical User Interface (“GUI”) dialog or group of dialogs, which allows the user to select (21) to edit an existing profile or create a new one. If the user selects to edit an existing profile, a list of existing profiles is provided. For example, the user may have previously defined the profiles as shown in TABLE 1, so the user may choose from the list of existing profiles as shown in TABLE 3, sorted by profile name, by the application program or system function to which a profile is assigned, or by User ID.

TABLE 3
Example Listing Accessibility Profiles
Choose a profile by: Application or

| Profile Name | System Function | User ID |
|---|---|---|
| Bob's Word | MSWord | bob |
| — | AutoDialer | bob |
| — | LotusMail | jill |
| — | CDPlayer | jill |
| All Standard | MSWord | — |

When the user selects an existing profile to edit, it is “opened” (22) for editing, such as opening the text file example given in TABLE 1. If the user selects to create (21) a new profile, a profile template is “opened” (23).

Next, a GUI is preferably provided to allow the user to select or change system accessibility settings for the selected profile, such as speaker volume level, microphone sensitivity, display contrast and font size, etc. Then, the user is optionally allowed to select (25) “companion” programs to automatically run when the application program is executed or system function is operated.

The user is prompted to assign (26) or re-assign the profile to an application program or system function. For example, in a computer system, the user may assign the profile to a word processor such that when the word processor is run, all of the system accessibility settings are automatically adjusted to those defined in the profile, and any companion programs are automatically launched. In a simpler device, such as a wireless telephone, this profile may be assigned to a system function, such as a speed dial key, which automatically causes the system accessibility settings to be adjusted when the speed dial key is operated. In this latter example, one might want to increase the microphone sensitivity on a wireless telephone when a particular speed dial key is operated because the user is aware that the usual recipient of the call is hearing impaired. Preferably, the user is also allowed to assign the profile to a user ID if the system has the capability of receiving user ID's from the user.

The user is also allowed to name (27) the profile, which allows it to be selected and enabled from a list of named profiles, such as the example given in TABLE 3.

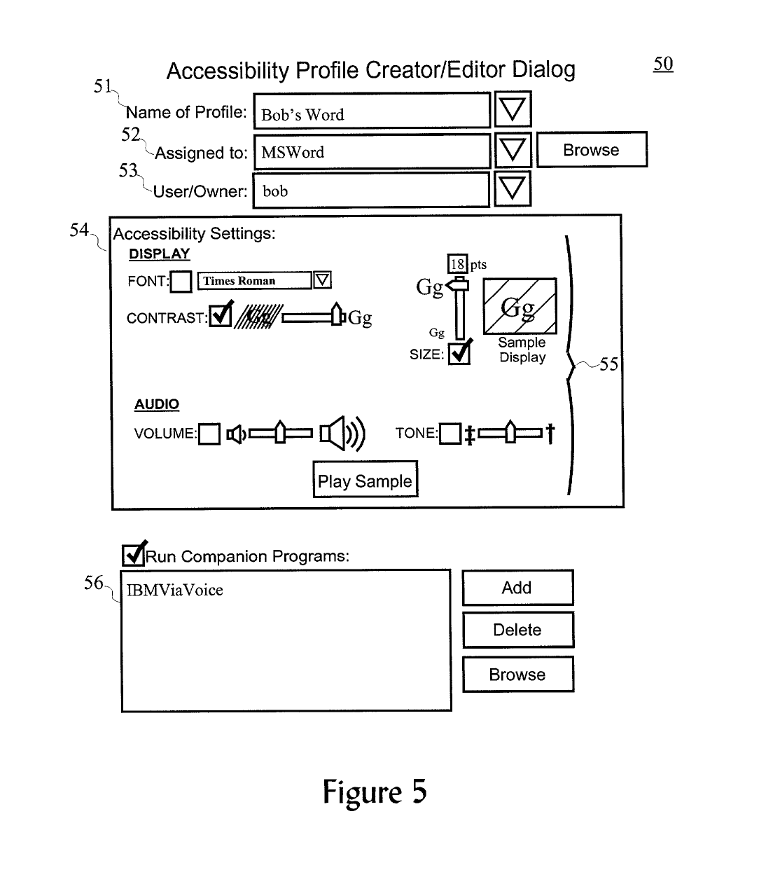

An example of such a GUI dialog for creating and editing profiles is shown in FIG. 5. The create/edit accessibility profile dialog (50) preferably provides a profile naming input (51), including a drop-down list button to display all previously named profiles. If a previously named profile is selected, all of the existing definitions for that profile are shown in the dialog for editing.

Further, an “assigned to” input (52) is provided to allow the profile to be assigned to a particular system function, such as an autodial key or F-key, or an application program, such as a word processor or spreadsheet program. A drop-down list button is preferably provided to allow the user to quickly select pre-defined system functions and/or application programs, as well as a “browse” button to allow the user to search for an application program within the system.

Also, the profile may optionally be associated with a specific user identifier by completing the “user/owner” input (53), which is also preferably provided with a drop-down list of predefined user names or ID's.

The create/edit accessibility profile dialog (50) also provides an group of accessibility settings (54) for each system feature that can be controlled via the profile, such as a group of check boxes or radio buttons, slider controls, or drop-down lists (55). If a setting is not specified to be changed, it will not be affected by the enabling of the profile. So, for this example of FIG. 5, if a user leaves the “speaker volume” checkbox unchecked, the speaker volume will not be changed when this profile is enabled. However, if the user does want the font to be set to a large size by this profile, the font slider may be moved to increase the font size setting. As shown in FIG. 5, the preferred embodiment of the accessibility profile dialog (50) includes an option to preview the setting being selected, such as playing an audio sound from the speaker when setting the speaker volume, or viewing an sample letter in its rendered size and contrast when adjusting the font size and contrast.

Also according to the preferred embodiment, a list (56) of companion programs or system functions is provided, which allows the user to add, delete, and browse for entries. These companion programs may themselves have accessibility profiles, as well.

Further according to the preferred embodiment, the records of the accessibility profile database (or data structures or text files) may be copied to portable media, such as a floppy diskette or CompactFlash card, or attached to an e-mail, for transport to another system or device to enable a user to use the accessibility profiles on that system or device.

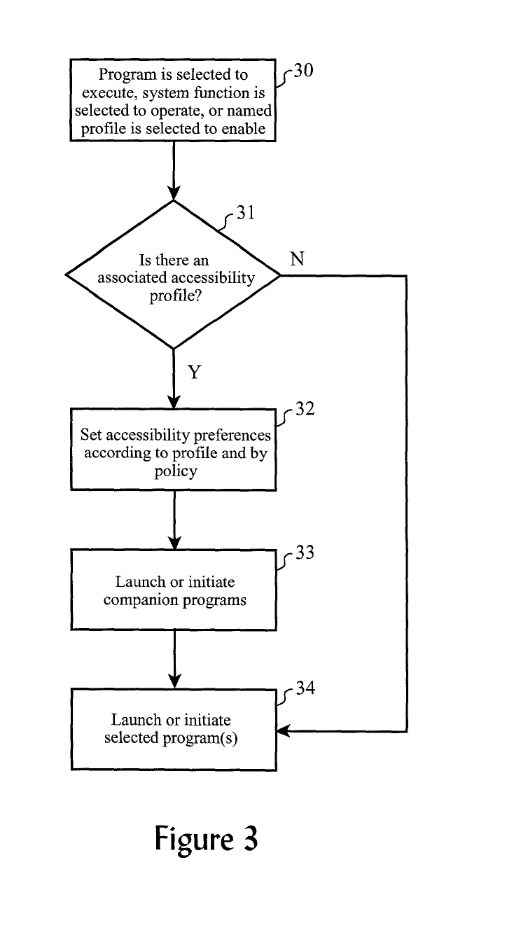

During operation of the system or device, the logical flow set forth in FIG. 3 is followed to automatically use the accessibility profiles and launch companion programs. Whenever a program is executed (30), a system function is operated, or a named profile is enabled, the system examines (31) the accessibility profiles for an existing profile assigned to the selected application program, system function, or profile name. If no profile exists, the selected program is launched normally (34). However, if a profile is found, the system accessibility settings and options are set (32) appropriately according to the accessibility profile, and any companion programs may be launched (33). Then, the selected program or system function is launched (34).

Preferably, a “policy” is provided by the operating system or Accessibility Profile Manager, which establishes the rules and logic which determine how profiles may override each other as they are enabled. For example, a simple policy would be that the last or most recent profile enabled supersedes or overrides all previous settings until the assigned program is terminated. So, if the profile named “All Standard” as given in TABLE 1 is first selected or enabled, and then later Bob logs into the system and runs MSWord, his profile named “Bob's Word” would be enabled. This would cause the font to be changed from medium to large, and the contrast to be set to high, and IBMViaVoice to be launched automatically. When the user terminates an instance of MSWord, the operating system or Accessibility Profile Manager would return the system settings to those defined by the “All Standard” profile, namely medium font size and standard display contrast.

Alternatively, the user may view a list of available named profiles through any of the common user interface methods such as selecting a menu function or an icon, or may use a system button such as a toggle switch. The user may then select a profile to “activate”, which causes the system accessibility settings to be adjusted according to the profile without having to run a specific application program or select a specific system function. For example, the user may have a profile named “Restaurant Mode” in a wireless telephone which may increase the speaker volume and decrease microphone sensitivity. This profile, though, is not assigned to an system function or application program, and can simply be selected from a menu of profiles or using a toggle switch when the user enters an environment with high ambient noise, such as a restaurant.

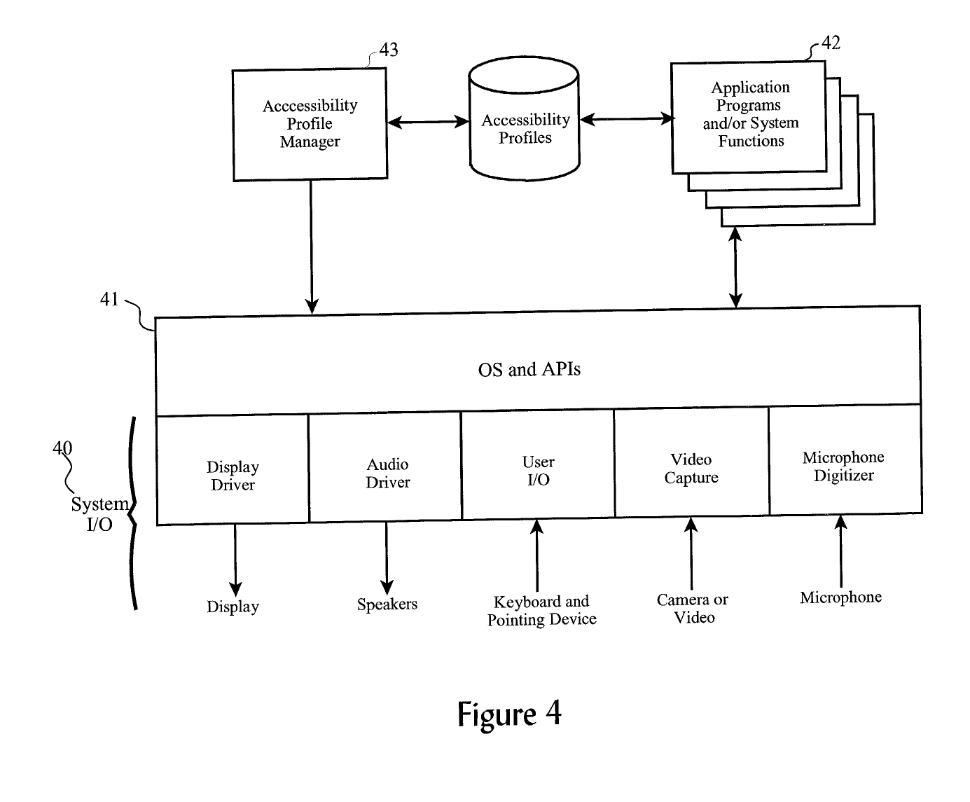

Turning to FIG. 4, the functional organization of the preferred embodiment is disclosed. The invention is realized as an program, the Accessibility Profile Manager (43), running under a personal computer operating system such as Linux or Microsoft Windows[TM]. These operating systems provide application program interface (“API”) functions (41) which allow programs such as the Accessibility Profile Manager (43) and application programs (42) to set system input/output parameters such as brightness for the display driver, volume for the sound card, keyboard speed and mouse responsiveness, etc. These types of operating systems also typically allow one application program to invoke other programs, and as such, the Accessibility Profile Manager (43) may invoke a user-selected program and other companion programs (42).

The system also includes a file, database or repository of accessibility profiles, preferably stored in system persistent memory such as FlashROM, battery-backed RAM, or a hard disk drive. The profiles are readable and modifiable by the Accessibility Profile Manager (43).

It will be recognized by those skilled in the art that a wide variety of implementation variations from the disclosed preferred embodiment may be adopted without departing from the spirit and scope of the invention, such as the use of a BlueTooth transceiver as the wireless interface, the targeting of the software for an embedded processor in an appliance or handheld device, or inclusion of gesture recognition software for processing images of sign language captured from a system camera. It will also be recognized that the profile enabling function can be performed responsive to system automatic execution of application programs, such as by the scheduling of a program to run by a CRON daemon in a UNIX-based computer. Certainly, alternate processor-based platforms, operating systems, and programming methodologies can likewise be adopted. It is intended that this description is for purposes of illustration only and should not be construed in a limiting sense. The scope of this invention should be limited only by the language of the following claims.

What is claimed is:

1. A method in a processor-based system for setting accessibility performance characteristics comprising the steps of:
providing a plurality of accessibility profiles, each accessibility profile containing one or more definitions of system accessibility performance characteristics; and
setting system accessibility performance characteristics according to definitions contained within a selected accessibility profile.

2. The method as set forth in claim 1 further comprising
assigning an accessibility profile to a system function or application program;
setting system accessibility performance characteristics according to definitions contained within a said assigned accessibility profile when a system function is operated or application program is executed.

3. The method as set forth in claim 1 further comprising the step of launching at least one companion application program or operating at least one companion system function as defined by said accessibility profile.

4. The method as set forth in claim 1 wherein said step of providing a plurality of accessibility profiles comprises providing a name for each accessibility profile.

5. The method as set forth in claim 1 wherein said step of providing a plurality of accessibility profiles comprises providing groups of accessibility profiles such that each group of accessibility profiles inherits the system accessibility performance characteristic definitions of its constituent accessibility profiles.

6. The method as set forth in claim 1 further comprises the step of transferring or copying one or more accessibility profiles from one system to another system.

7. The method as set forth in claim 1 wherein said step of providing accessibility profiles comprises providing an association between accessibility profiles and user names or user identifiers.

8. A computer-readable media containing computer-executable program code for setting accessibility performance characteristics of a computer-based system, said program code causing the computer-based system to perform the steps of:
providing a plurality of accessibility profiles, each accessibility profile containing one or more definitions of system accessibility performance characteristics; and
setting system accessibility performance characteristics according to definitions contained within a selected accessibility profile.

9. The computer-readable media as set forth in claim 8 further comprising program code for:
assigning an accessibility profile to a system function or application program;
setting system accessibility performance characteristics according to definitions contained within a said assigned accessibility profile when a system function is operated or application program is executed.

10. The computer-readable media as set forth in claim 8 further comprising program code for performing the step of launching at least one companion application program or companion system function as defined by said accessibility profile.

11. The computer-readable media as set forth in claim 8 wherein said program code for providing a plurality of accessibility profiles comprises program code for providing a name for each accessibility profile.

12. The computer-readable media as set forth in claim 8 wherein said program code for performing the step of providing a plurality of accessibility profiles comprises program code for providing groups of accessibility profiles wherein each group of accessibility profiles inherits the system accessibility performance characteristics definitions of its constituent accessibility profiles.

13. The computer-readable media as set forth in claim 8 further comprising program code for transferring or copying one or more accessibility profiles from one system to another system.

14. The computer-readable media as set forth in claim 8 wherein said program code for providing accessibility profiles comprises program code to associate accessibility profiles to user names or identifiers.

15. A system for managing user accessibility characteristics comprising:
a plurality of accessibility profiles, each accessibility profile defining a set of user-preferences for system accessibility characteristics for an assigned system function or application program; and
an accessibility profile manager for setting system accessibility characteristics according to one or more accessibility profiles.

16. The system as set forth in claim 15 wherein at least one accessibility profile contains an assignment to a system function or application program, and wherein said accessibility profile manager is adapted to set system accessibility characteristics according to an assigned accessibility profile responsive to operation of a system function or execution of an application program.

17. The system as set forth in claim 15 further comprising a companion operator for automatically operating a companion system function according to definitions in an accessibility profile.

18. The system as set forth in claim 15 further comprising a companion executor for automatically executing a companion application program according to definitions in an accessibility profile.

19. The system as set forth in claim 15 further comprising a group accessibility profile, said group accessibility profile defining a set of user-preferences for system accessibility characteristics for an assigned system function or application program according to inherited system accessibility characteristics definitions from a plurality of accessibility profiles.

20. The system as set forth in claim 15 further comprising a profile transferor for transferring and copying accessibility profiles between systems.

21. The system as set forth in claim 15 further comprising a profile namer for assigning user-defined names to accessibility profiles.

22. The system as set forth in claim 15 further comprising a user ID associator which automatically selects an accessibility profile based upon a user-supplied identifier.
